(19) United States
(12) Patent Application Publication
(10) Pub. No.: US 2017/0138097 A1
(43) Pub. Date: May 18, 2017

(54) SEAMLESS EXTERIOR HANDLE FOR A VEHICLE DOOR

(71) Applicant: Ford Global Technologies, LLC, Dearborn, MI (US)

(72) Inventor: Rajesh K. Patel, Farmington Hills, MI (US)

(73) Assignee: Ford Global Technologies, LLC

(21) Appl. No.: 15/416,602

(22) Filed: Jan. 26, 2017

Related U.S. Application Data
(63) Continuation of application No. 13/769,662, filed on Feb. 18, 2013, now Pat. No. 9,593,514.

(51) Int. Cl. E05B 81/90; E05B 17/10; E05B 19/00; E05B 85/06; E05B 85/16; E05B 19/04

(52) U.S. Cl. CPC E05B 81/90; E05B 85/16; E05B 19/043; E05B 19/0082; E05B 85/06; E05B 17/10

(57) ABSTRACT

A vehicle door includes a lock cylinder having an actuator member that is operably connected to a door latch mechanism. A door handle is movably connected to the door structure for movement from a first or home position covering an outer end of the lock cylinder to a partially open position wherein the outer end of the lock cylinder is exposed. When the door handle is in the partially open position, a user can access the lock cylinder and insert a key into the lock cylinder to unlock the door then pull the handle to a fully open position. Thus, the lock cylinder is covered and hidden behind a portion of the door handle when the door handle is in the first position to provide an uncluttered, visually appealing appearance.

### CROSS REFERENCE TO RELATED APPLICATION

This application is a continuation of U.S. patent application Ser. No. 13/769,662, filed Feb. 18, 2013, entitled “SEAMLESS EXTERIOR HANDLE FOR A VEHICLE DOOR,” the entire disclosure of which is incorporated herein by reference.

### FIELD OF THE INVENTION

The present invention generally relates to door handles for vehicles, and in particular a seamless (or continuous) exterior door handle without a separate bezel or keyhole as is the case with current handle designs.

### BACKGROUND OF THE INVENTION

Various exterior door handles for motor vehicles have been developed. A known type of design includes a separate bezel and an exposed lock cylinder that receives a key for rotation of the lock cylinder. However, known exterior door handle designs suffer from various drawbacks. For example, an exposed keyhole is required to provide access to the lock cylinder, and this may degrade the appearance of the vehicle. Known handle designs utilize a fixed bezel with a keyhole, features that are not required according to the present invention. In addition, with the proliferation of power locking as a standard feature now on almost all vehicles (except the low series of a low segment e.g. B-segment low series), the lock cylinder is only for emergency use under a low battery or power loss situation.

### SUMMARY OF THE INVENTION

One aspect of the present invention is a door for motor vehicles including a door structure having inner and outer sides, an outer perimeter, and an interior space. The outer side of the door includes a generally smooth outer surface defining a surface contour. The door further includes a latch mechanism that is adapted to selectively retain the door in a closed position when the door is mounted to a vehicle. The door also includes a lock cylinder assembly having an outer end. The outer end has an opening that is configured to receive a key to unlock the door. The outer end is disposed on the outer side of the door, and the lock cylinder has an inner end disposed in the interior space. The inner end has an actuator member that is operably connected to the door latch to operate the door latch via a cable or other suitable arrangement to operate the door latch such that the rotational motion of the key during locking/unlocking is transferred to linear motion of the cable via the bell crank (inward end of the lock cylinder). The door still further includes a handle that is movably connected to the door structure for movement from a first position wherein a portion of the handle completely covers the outer end of the lock cylinder to an open position wherein the outer end of the lock cylinder is exposed to permit a key to be inserted into the space between the partially open handle and the outer face of the lock cylinder. The handle is seamless (continuous) and it does not use a fixed bezel with a keyhole as is the case on current handle designs. The covered lock cylinder arrangement potentially provides for a more pleasing and refined appearance, improved aerodynamics, reduced windnoise and protects the lock cylinder from environmental degradation and loss of function.

Another aspect of the present invention is a folding emergency extended length key that may be utilized to reach the hidden lock. The folding key may be configured to double in length by unfolding when needed to be used to unlock the vehicle manually using this key. The key can be folded and securely stored inside a passive entry keyfob having one or more buttons or the like that can be actuated by a user to remotely lock and unlock the vehicle door. The keyfob securely stores/retains the folding emergency key, and includes a sliding cover, a brand logo with illumination upon locking or unlocking to indicate the lock state of the vehicle directly on the fob. This is possible when a user is within a range utilized by current keyfobs (e.g. 30-50 feet). The lock state is recorded on the fob without additional battery consumption. A user van verify that the vehicle is locked by activating the fob lock button a second time or by viewing the lock state indication (if any) on an inside of the door.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a partially fragmentary isometric view of a door handle according to one aspect of the present invention;

FIG. 2 is a partially fragmentary isometric view of the door handle of FIG. 1 in a partially open position;

FIG. 3 is a partially fragmentary isometric view of the door handle of FIG. 1 in a fully open position wherein the lock cylinder is exposed for use by insertion of a key;

FIG. 3A is an isometric view of a chassis of the door handle of FIG. 1;

FIG. 3B is an isometric view of a chassis of the door handle of FIG. 1;

FIG. 3C is a partially fragmentary view of a chassis of the door handle of FIG. 1;

FIG. 4 is a vertical section view of the door handle through the center of the key cylinder as viewed from the rear end of the door handle of FIG. 1;

FIG. 5 is a top plan view of a folding key according to one aspect of the present invention;

FIG. 6 is a front elevational view of the folding key;

FIG. 7 is a plan view of the folding key in a partially folded condition;

FIG. 8 is a plan view of the folding key in a fully folded condition;

FIG. 9 is an isometric view of a keyfob for storing the folding key;

FIG. 10 is an isometric view of a keyfob of FIG. 9; and

FIG. 11 is an isometric view of the keyfob with a sliding door in an open position.

### DETAILED DESCRIPTION OF THE PREFERRED EMBODIMENTS

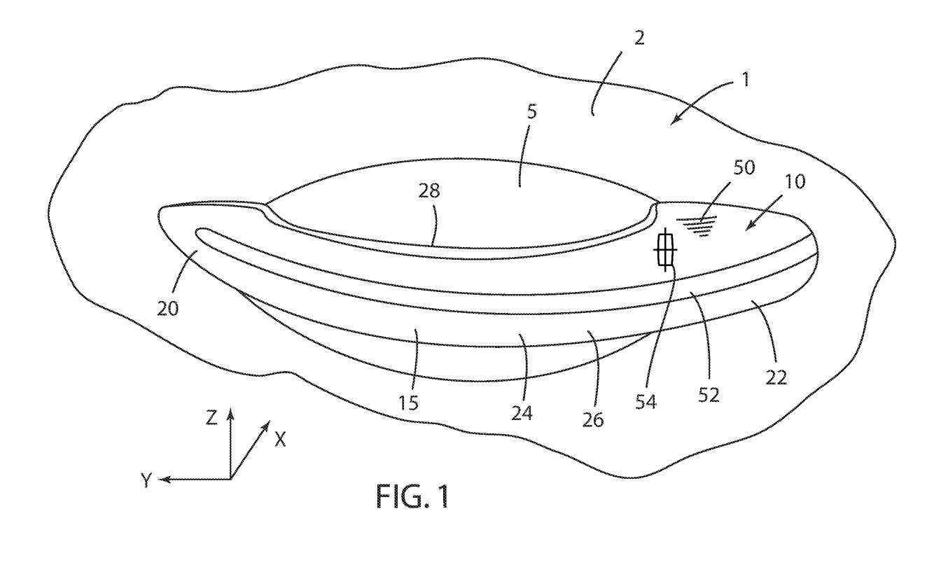

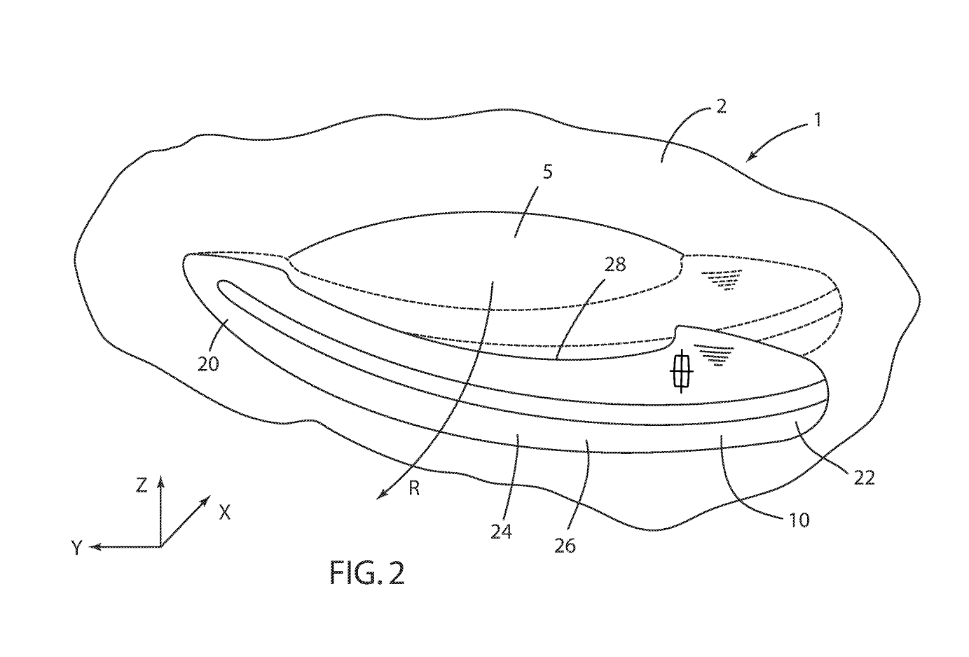

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 1, a vehicle door 1 according to one aspect of the present invention includes a handle assembly 10 that is disposed adjacent, or in contact with, exterior surface 2 of vehicle door 1. Exterior surface 2 may be a “class A” surface that is painted or otherwise finished to provide a finished appearance. The exterior surface 2 may comprise a layer of sheet metal, composite material, or other suitable material that is painted according to known methods. A pocket or depression 5 is formed in the exterior surface 2. The pocket 5 may also be painted or otherwise finished, and it may be stamped or formed by other known processes. Significantly, according to the present invention, no separate bezel or exposed keyhole are present.

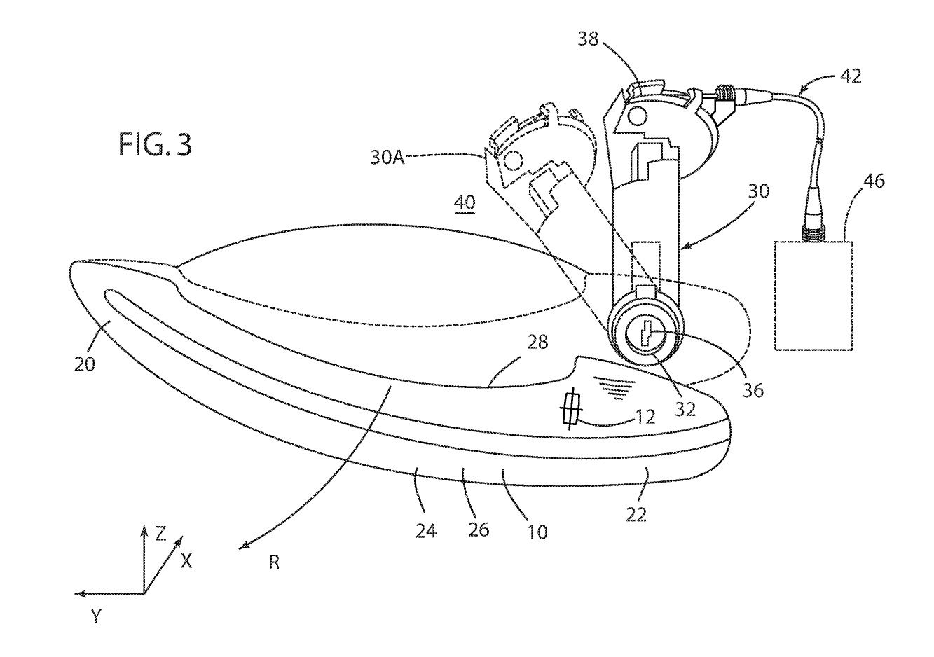

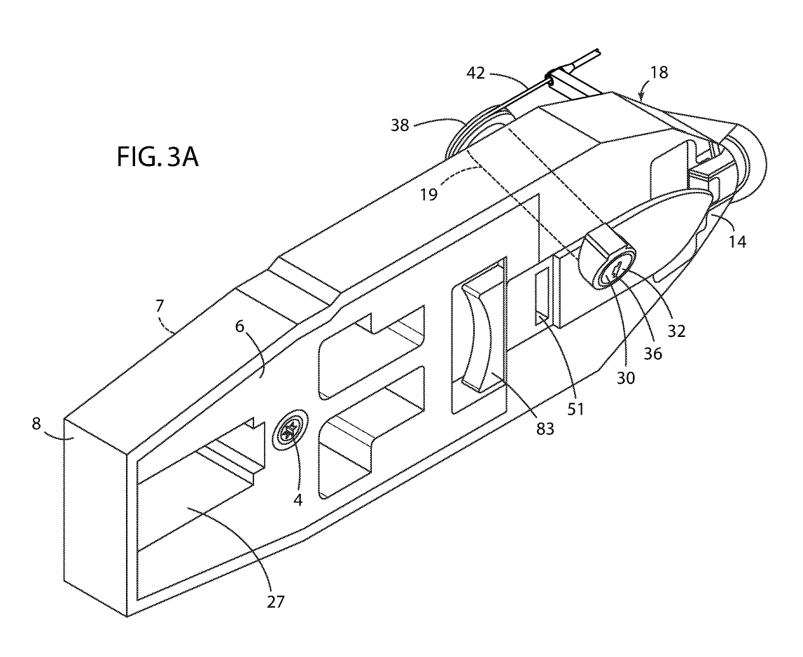

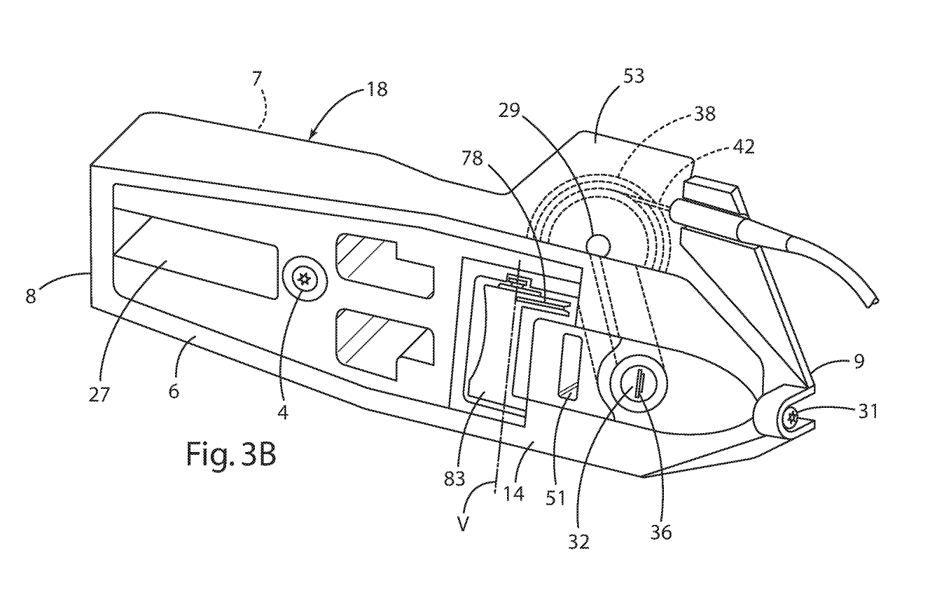

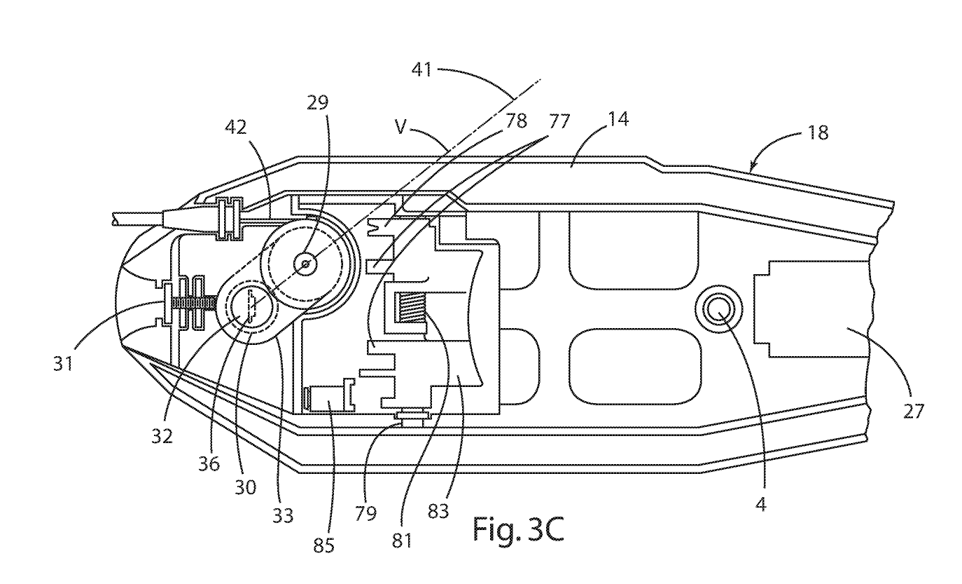

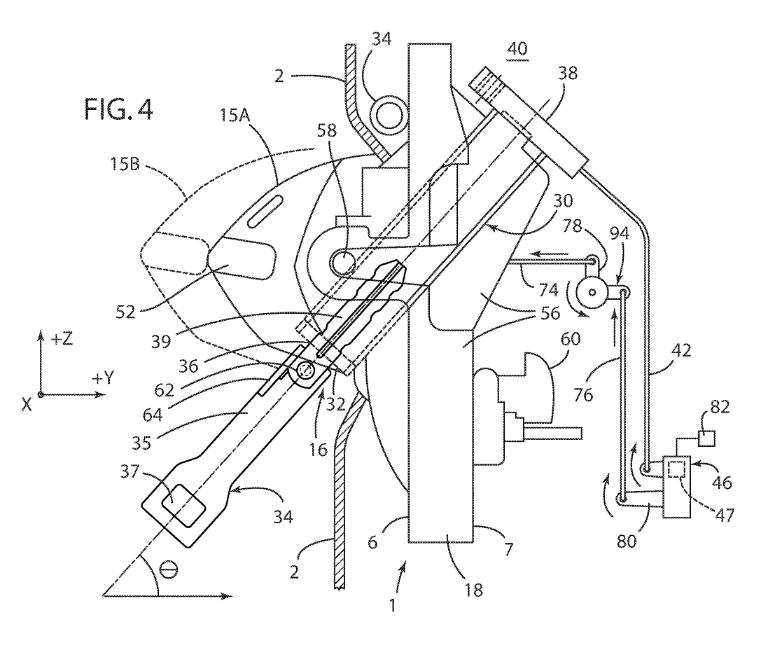

The handle assembly 10 includes a seamless continuous handle member 15 that is rotatably or pivotably connected to an inner door structure or chassis 18 (see also FIGS. 3A and 4) for rotation about a generally vertical axis Z (in vehicle coordinates) as shown by the arrow “R.” As discussed in more detail below, chassis 18 accommodates a hidden lock cylinder 30 that extends both upwardly and forwardly to permit user access to outer end 32 (also called “lock shutface”) of lock cylinder 30. A remote (powered) door lock is normally utilized to unlock latch 46 (FIG. 4). However, lock cylinder 30 can be accessed to manually unlock latch 46 in the event the remote (powered) door lock feature fails. The present invention includes a seamless (continuous) handle 15 that does not use a fixed bezel with a keyhole as is the case in current handle designs. Handle member 15 generally includes a front or forward end 20, a rear or rearward end 22, and an elongated central portion 24 extending between the forward end 20 and the rearward end 22. The elongated central portion 24 has a compound convex outer surface 26, and a smoothly curved concave inner surface 28 configured to be grasped by a user. The central portion 24 generally extends in a fore-aft direction when the handle member 15 is in the closed position as shown in FIG. 1. When handle member 10 is in the fully closed position of FIG. 1, the handle member 10 completely covers and hides lock cylinder 30 (FIG. 3). Significantly, handle member 15 is continuous or seamless. In other words, there is no split line between the handle and a fixed bezel or cap and there is no keyhole, features that are present in current handle designs.

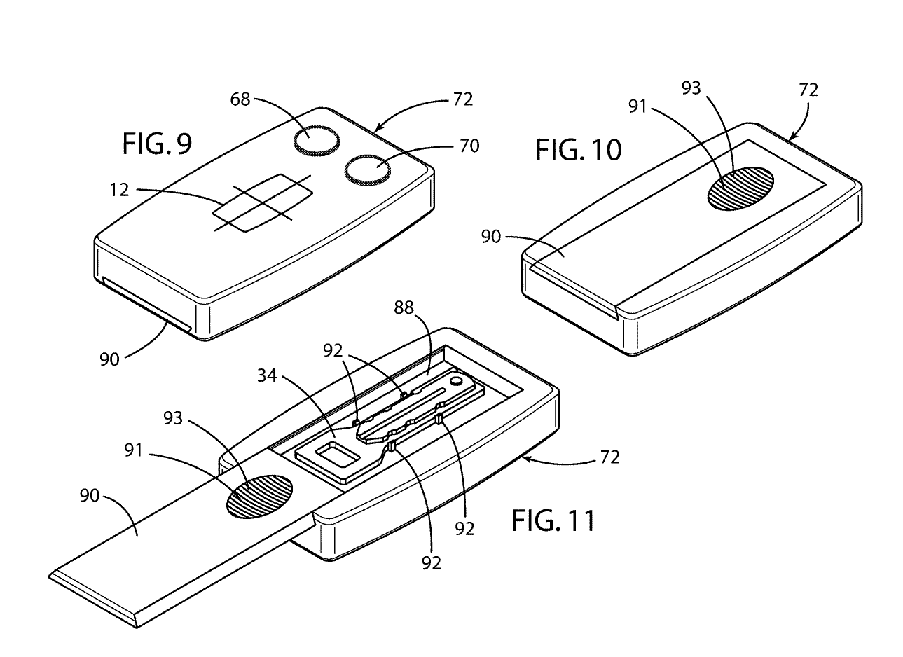

With further reference to FIG. 4, handle member 15 is operably connected to latch 46 by linkage 94. Linkage 94 comprises elongated rods 74 and 76, and a bell crank 78. The bell crank 78 may be mounted for rotation about a substantially vertical axis (“V”) as shown in FIGS. 3B and 3C. It will be understood that cables may be utilized in place of rods 74 and 76. Bell crank 78 is a component of the handle chassis 18 and is spring actuated with a metal pivot pin. The pivot pin is secured to the handle chassis 18 with a fastener in a known manner. The bell crank 78 is not the focus of this invention and therefore how it attaches to the handle chassis 18 has therefore not been shown. Handle member 15 can be rotated from a rest position designated “15A” to a partially opened position “15B.” This forms a temporary gap or opening 16 between partially opened handle member 15B and outer end 32 (shutface) of lock cylinder 30. If latch 46 is unlocked, further outward rotation of the handle member 15 shifts elongated connector 74 outwardly, which thereby rotates bell crank 78. This, in turn, causes the elongated connecting member 76 (rod or cable) to shift linearly, thereby actuating lever 80 to unlatch door latch 46. As discussed in more detail below, lock cylinder 30 is not used during normal operation. Rather, a user utilizes a remote keyfob 72 (FIGS. 9-11) or a keyless entry system to power unlock the actuator latch 46 via powered actuator 47. After unlocking latch 46, user then pulls handle member 15 to the fully opened position to mechanically unlatch the door latch 46 due to movement of elongated connecting members 74 and 76 (which can be a rod or a single cable). However, the lock cylinder 30 may be accessed to unlock latch 46 if vehicle power is lost and/or powered actuator 47 malfunctions, or other such emergency.

Lock cylinder 30 is preferably mounted at an accessible angle to provide for ergonomic use thereof in the event powered actuator 47 cannot be used to unlock latch 46. In the illustrated example, the lock cylinder 30 is positioned at an angle θ (FIG. 4) of about 45° relative to the Z-axis. Also, the lock cylinder 30 may be angled forward between the X and Y-axes as shown by the dashed lines designated 30A in FIG. 3. Although various angles could be utilized, in the illustrated example the lock cylinder 30 is angled at about 45° relative to the X and Y-axes. Inner end 38 of lock cylinder 30 is disposed behind exterior surface or skin 2 in an interior space 40. The term “interior space” as used herein merely designates an area that is behind or inward of the front end 32 of lock cylinder 30, or inboard of the outer skin or surface 2. An elongated connector 42 (FIG. 3) mechanically connects inner end 38 of lock cylinder 30 to a door latch 46. Connector 42 may comprise a cable, a rod or other suitable connector. Various types of suitable cables and rods for interconnecting a lock cylinder to a door latch are known, and the configuration of connector 42 will not, therefore, be described in detail. Door latch 46 may include a conventional “fish mouth” 45 that provides clearance for a striker.

The cable 42 operably interconnects the lock cylinder 30 to a vehicle door latch 46, such that rotation of lock cylinder 30 upon insertion of end 39 of key 34 causes the lock portion of door latch 46 to unlock. The rotational movement of the key (upon insertion into the lock cylinder 30) causes the innermost portion (bell crank 38) of the lock cylinder, to rotate, and bell crank 38 transfers the rotational movement into linear movement of the cable or rod 42 as shown in FIGS. 3, 3A, and 4.

Referring again to FIG. 4, movement of handle member 15 from the rest position 15A to the partially opened position 15B creates a gap 16 between end 22 of handle 15 and the outer end 32 of lock cylinder 30. A user can then insert the end 39 of key 34 into opening 36 of outer end 32 of lock cylinder 30. The end 39 of key 34 is extra long to permit access to lock cylinder 30.

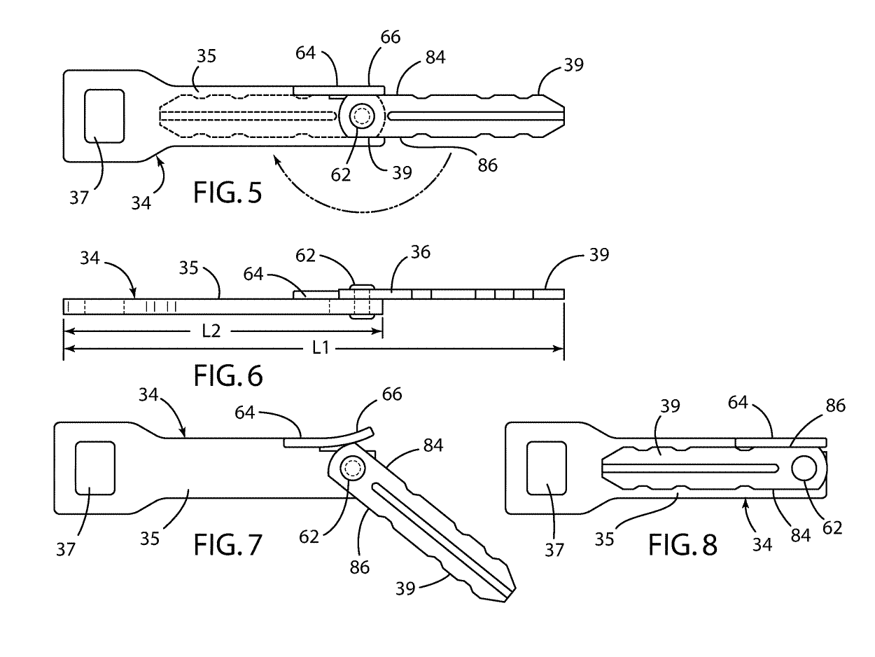

With further reference to FIGS. 5-8, key 34 includes a base 35 and an end 34 that is pivotably connected to the base 35 at a pivot 62. Pivot 62 may comprise a pressed pin, a rivet-type connection, or other suitable arrangement. The pivot connection 62 is preferably a relatively high friction connector whereby the end 39 tends to stay at a selected angular position relative to the base 35. The base 35 includes a stop or lock 64 in the form of a flexible tab 66. The stop 64 retains the end 39 in either the fully deployed position of FIG. 5 or fully folded position of FIG. 8. The lock 64 prevents rotation of end 39 relative to base 35 beyond the 180° fully-deployed position shown in FIG. 5. Specifically, the flexible tab 66 contacts the edge 84 of base 39 when the key is in the fully deployed (180°) configuration shown in FIG. 5 to prevent further rotation of end 39 relative to base 35. The tab 66 contacts the edge surface 86 of end 39 when end 39 is in the folded or retracted position of FIG. 8. In a preferred embodiment, the base 34 is made of a molded polymeric material having sufficient flexibility to permit flexing of the tab 66, and the end 39 is made of steel or other suitable material. The overall length of L1 (FIG. 6) is about 110 mm to about 120 mm, and the length of the base L2 is about 70 mm to about 80 mm. Base 35 optionally includes an opening 37 that may be utilized to connect the key 34 to a key chain or the like.

With further reference to FIGS. 9-11, key 34 may be stored in a cavity 88 of a keyfob 72. Keyfob 72 includes a slideable door or cover 90 that can be shifted from an open position (FIG. 11) to a closed position (FIG. 10). Fob 72 may include a plurality of barbed posts 92 that receive and retain key 34 in cavity 88. Keyfob 72 may include pushbuttons 68 and 70 for remote locking/unlocking of the vehicle latch 46 utilizing powered actuator 47. Fob 72 may also include a brand logo 12 or the like to identify the make of the vehicle.

Referring again to FIG. 1, the door 1 may include a Passive Entry Passive Start (“PEPS”) system including a sensor 50 mounted on handle member 15. The sensor 50 senses the presence of keyfob 72 (FIGS. 9-11) and determines if the keyfob is authorized. Sensor 50 may comprise an antenna that receives signals from fob 72, and sensor 50 may further include a proximity sensor that senses if a user's hand is within a predefined distance of the handle member 15. The PEPS system may be substantially the same as the PEPS system described in pending U.S. Application No. 61/666,280, the entire contents of which are incorporated by reference. Although the PEPS system/sensor 50 is an optional feature, it may comprise the primary way in which door latch 46 is unlatched. Thus, lock cylinder 30 may be utilized as a manual backup in case the sensor 50 or other electrical components experience a failure due to a power loss or the like.

Handle member 15 may include an elongated chrome strip 52 that is illuminated by LEDs (not shown) disposed behind the chrome strip 52. Also, an LED or other illuminated symbol 54 forms a lock state indicator that may be utilized to indicate the lock condition. For example, the light 54 may illuminate if the vehicle is unlocked, thereby signaling to a user that the sensor 50 has detected the presence of an authorized user. The light 54 may comprise a vehicle brand symbol or logo, or other appropriate indicia. An audio signal may also be produced when the lock is unlocked to alert a user of the state of the lock.

FIGS. 3A, 3B, 3C and 4, show a structural member of the handle known as the chassis 18, and chassis side attachment fasteners 58. Chassis 18 accommodates the hidden angled lock 30 in an angled manner that is unique relative to existing handle chassis. Chassis 18 may include a variety of mounting features/structures as required for a particular application. Chassis 18 includes a body 14 formed of polymer or other suitable material. Body 14 includes an outer side 6, an inner side 7, a front end portion 8, and a rear end portion 9. When installed, chasses 18 is disposed inwardly of outer skin 2 of door 1, with outer side 6 of chassis 18 facing outer skin 2. Threaded fasteners 4 or other suitable fasteners are utilized to secure chassis 18 to the door 1. One or more mounting/locating features such as hooks (not shown) can be utilized in conjunction with threaded fastener 4 to secure chassis 18 to the vehicle door. In general, outer face 6 of chassis 18 may be configured to contact the inner surface of door skin 2 (FIG. 4), and a bezel core (not shown) may be disposed against an outside surface of door skin 2, and threaded fasteners 4 may be utilized to secure the chassis 18 to the bezel core with the door skin 2 sandwiched between the bezel core and the chassis 18. The bezel core, hooks, and fasteners utilized to secure chassis 18 to the door skin 2 may be substantially similar to known handle securing arrangements, and these features are not therefore described in detail. A threaded fastener 31 secures the lock cylinder 30 to the chassis 18. With reference to FIG. 3C, lock cage 33 is formed integrally with chassis 18, and forms a compound angle with respect to the X and Y axes of the vehicle. The axis 41 of lock cylinder 30 is disposed at a compound angle with respect to the vehicle X and Y axes. For example, the lock cylinder 30 may be disposed at a 45° angle with respect to the vehicle Y and Z axes, and at 135° with respect to the vehicle X axis.

Referring again to FIG. 3C, bell crank 78 is pivotably mounted to the chassis 18 by a bell crank pin 79. A torsion spring 81 and counter balance 83 counter balance inertial forces generated by the other components in the event the vehicle experiences lateral acceleration. These components may be substantially similar to existing counter balance arrangements that are known in the art, and these features are therefore not described in detail herein. An inertia lock 85 may be utilized to prevent inadvertent opening of the handle 10, and may comprise a known inertia lock. In general, the bell crank 78 and counter balance 83 may comprise an integral, one-piece unit. The unit may further include a handle capture feature 77 that may be substantially similar to known units. The lock cylinder 30 includes a lock cylinder shaft 29 that is operably connected to the bell crank 38 at the inner end of lock cylinder 30. In general, the bell crank 38 converts rotary motion of lock cylinder shaft 29 into linear motion of rod or cable 42 in a known manner.

A channel 51 in housing 18 provides clearance for the handle rear arm or plunger. The chassis 18 also includes a channel or slot 27 that provides clearance for the forward pivot arm of the handle 10. With reference to FIG. 3B, chassis 18 may include a flange or theft shield 53 that extends upwardly from the main body of chassis 18 to protect the inner end or bell crank 38 of lock cylinder 30.

Significantly, chassis 18 includes an angled bore 19 that receives lock cylinder 30 at an angle such that a user can gain access to outer end 32 of lock cylinder 30 for insertion of key 34. As discussed above, lock cylinder 30 is preferably angled upwardly at an angle θ (FIG. 4) of about 45°, and is also angled forwardly at an angle of about 45° relative to the X and Y-axes. The handle assembly 10 may also include an inertia lock 60 to prevent opening of handle assembly 10 if the vehicle is experiencing acceleration in a lateral direction (i.e. in the direction of the Y-axis; FIG. 4) due to a side impact on the vehicle. Inertia locks are known in the art, and the details of inertia lock 60 will not therefore be described in detail herein. It will be understood that the chassis 18 may have a wide range of constructions as required for a particular application and the structure or chassis 18 is not limited to the specific structure shown in FIGS. 3A-3C and 4. Also, the handle member 15 may be mounted for rotation about the X or the Y-axis, or a combination of rotations about the X, Y, and/or Z-axes.

Referring again to FIG. 1, in use a user approaches the vehicle door 1 with the handle assembly 10 in a closed configuration as shown in FIG. 1. During normal operation, the sensor 50 verifies that the fob 72 is that of an authorized user. The vehicle controller 82 (FIG. 4) then illuminates light 54, and causes the door latch 46 to power unlock utilizing powered actuator 47. As discussed above, the sensor 50 may include a proximity sensor whereby the vehicle controller does not unlock the vehicle door latch 46 unless a user's hand is within a specified distance of sensor 50. Also, at night the chrome strip 52 may be illuminated upon receiving a signal from an authorized keyfob 35 to light up and guide a user towards the door handle. A user can also utilize keyless entry fob 72 to remotely actuate powered actuator 47 to unlock latch 46. The user can then pull the door handle member 15 to the open position (FIG. 3), thereby unlatching the door latch 46 due to movement of linkage 94. The user then releases the handle 10, and a spring (not shown) returns the handle to the fully closed position shown in FIG. 1, and the user then enters the vehicle. The vehicle then determines if the keyfob 35 is that of an authorized user, and starts the vehicle's engine if the proper authorization conditions are met.

In the event the user approaches the vehicle, and the sensor 50 does not unlock the latch 46 due to a power failure or other problem, the symbol 54 will not light up, thereby alerting the user that the vehicle door has not been unlocked. The user can then grasp the handle member 15, and rotate it part of the way out to position 15B (FIG. 4), thereby gaining access to the lock cylinder 30. A user then extends the end 39 of the key 34 and inserts it into the opening 36 of lock cylinder 30. The key 34 is then rotated to shift rod or cable 42 to mechanically unlock the door latch 46. The user can then pull the handle member 50 into the fully open position of FIG. 3, thereby unlatching the door latch 46.

The door handle of the present invention is seamless in that it does not incorporate a separate bezel (as is the case with current handle designs) and it has no keyhole (as is the case with current handle designs). The door handle of the present invention can be utilized on a wide range of vehicles. Furthermore, the door handle can be configured to provide a pleasing visual appearance that is also aerodynamic. This is because there is no margin between the handle and a fixed bezel as is the case with current handle designs, and also because there is no exposed keyhole. This in turn may substantially reduce the air-leakage and associated windnoise generated compared to current designs having a keyhole and a margin between the handle and a fixed bezel. Because the lock cylinder 30 is hidden behind the door handle 10 when the door handle 10 is in the closed position, the lock cylinder 30 is not normally visible and there is no exposed keyhole (as is the case on current handle designs which incorporate a fixed separate bezel).

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle door comprising:
a door structure having an inner side and an outer side having an outer surface, the door structure defining a Z-axis that extends vertically, a horizontal Y-axis that extends in a forward direction, and a horizontal X-axis that extends inwardly from the outer side towards the inner side;
a latch mechanism connected to the door structure, wherein the latch mechanism is configured to retain the door in a closed position when the latch mechanism is latched and to permit opening of the door when the latch mechanism is unlatched;
a lock mechanism connected to the door structure;
a lock assembly, the lock assembly having an outer end, the outer end having an opening, wherein the outer end is disposed on the outer surface of the door structure, and wherein the lock assembly is operably connected to the lock mechanism such that actuation of the lock assembly causes the lock mechanism to shift from a locked state to an unlocked state;
an elongated handle strap that is seamless and continuous with a central portion extending in a fore-aft direction along the Y-axis and opposite forward and rearward ends, the forward and rearward ends having side faces with peripheral edges extending around the side faces, wherein the peripheral edges fit closely against the outer surface of the door when the elongated handle strap is in a closed position;
wherein the forward end of the elongated handle strap is pivotably connected to the door structure for pivoting movement about the Z-axis from a fully closed position wherein the rearward end of the elongated handle strap completely covers and hides the outer end of the lock assembly with the peripheral edge of the rearward end extending around the outer end of the lock assembly such that the outer end of the lock assembly is not visible, to a partially open position wherein the rearward end of the elongated handle strap is spaced apart from the outer end of the lock assembly and the outer end of the lock assembly is exposed, and wherein the central portion of the elongated handle strap is spaced apart from the outer surface of the door structure when the elongated handle strap is in the fully closed position to define a gap that opens upwardly and downwardly to provide clearance permitting a user to insert a portion of a hand downwardly into the gap and grasp the central portion of the elongated handle strap when the elongated handle strap is in the fully closed position and to manually move the elongated handle strap from the fully closed position to the partially open position without unlatching the latch mechanism, and wherein movement of the elongated handle strap from the partially open position to a fully open position unlatches the latch mechanism.

2. The vehicle door of claim 1, wherein:
the outer surface of the door structure comprises a sheet of material forming an outwardly-facing pocket.

3. The vehicle door of claim 2, wherein:
the elongated handle strap extends across the outwardly-facing pocket.

4. A vehicle door comprising:
an outer side;
a lock assembly configured to receive a key to unlock the lock assembly, the lock assembly having an outer end;
a seamless, continuous elongated strap handle member having a forward end that is pivotably coupled to the door whereby the handle member pivots about a vertical axis, the handle member having a rear end portion that is configured to move relative to the outer end of the lock assembly between a completely closed, covered position and a partially opened uncovered position to selectively cover and uncover the outer end of the lock assembly, and wherein a central portion of the handle member between the forward end and the rearward end is spaced apart from the outer side to define a gap that opens upwardly and downwardly when the handle member is in the completey closed position, respectively to permit a user to insert portions of a hand downwardly into the gap and grasp the handle member when the handle member is in the completely closed covered position and manually pivot the handle member outwardly about the vertical axis to move the rear end portion away from the outer end of the lock assembly thereby permitting a key to be inserted into the outer end of the lock assembly.

5. A vehicle door, comprising:
a door structure;
an elongated curved handle pivotably mounted to the door structure for rotation about a vertical axis;
a lock cylinder defining a keyhole that is completely covered and hidden by an inwardly-extending rear end of the handle when the handle is in a fully closed position, the keyhole being accessible to receive a key when the handle is in a partially opened position between the fully closed position and a fully open position.

6. The vehicle door of claim 5, wherein:
the handle comprises an elongated handle strap that is seamless, continuous without a bezel or a keyhole.

7. The vehicle door of claim 6, wherein:
the lock cylinder defines an axis that extends upwardly and/or forwardly such that a key can be inserted into the keyhole by shifting the key upwardly and/or forwardly along an axis of the key.

8. The vehicle door of claim 5, wherein:
the door includes a lock, and the handle includes a light that illuminates if the lock is unlocked.
